(19) United States
(12) Patent Application Publication
(10) Pub. No.: US 2025/0312702 A1
(43) Pub. Date: Oct. 9, 2025

(54) SWING FOR PERSON AND DOG

(71) Applicant: PlayCore Wisconsin, Inc., Chattanooga, TN (US)

(72) Inventors: Jonathan Walden, Chattanooga, TN (US); Jacob Arbeiter, Chattanooga, TN (US)

(21) Appl. No.: 18/630,139

(22) Filed: Apr. 9, 2024

(51) Int. Cl. A63G 9/00; A01K 15/02; F16G 13/12

(52) U.S. Cl. CPC A63G 9/00; A01K 15/025; F16G 13/12

(57) ABSTRACT

A swing assembly is configured for shared enjoyment by a person and a dog. A swing seat may include a framework and a surface material that provides a desired combination of slip resistance and softness. The swing seat may be suspended from first and second support posts positioned to the sides of the swing seat, thereby reducing side-to-side rocking of the swing seat. One or more tether elements may limit the movement of the swing seat in the swinging direction and optionally help reduce side-to-side rocking of the swing seat, such that the swing seat has an appropriate level of stability for a dog during use.

### SUMMARY OF THE INVENTION

The present disclosure is directed to a swing assembly that can be installed in a public recreational space, such as a park, dog park, playground, etc., and which is configured for use by a person and a canine companion.

In embodiments of the present disclosure, the swing assembly may comprise a swing seat and a tether that connects the seat to a ground surface on which the swing assembly is mounted, and which limits the forward and rearward movement of the swing seat. The present inventors have determined that most dogs do not appreciate the instability that comes with a significant swinging motion of the sort generally enjoyed by children (and adults), but may find a more subtle swinging motion enjoyable, or at least unobjectionable. Accordingly, embodiments of the present disclosure are configured to limit the swinging motion of the swing seat to within a range that has been found to be acceptable to most dogs.

In embodiments of the present disclosure, the swing assembly may comprise a swing seat that is not suspended from an overhead support as a conventional playground swing, but rather which is suspended from first and second support posts, the first and second support posts being positioned to the first and second sides of the swing seat. In much the same way that most dogs do not appreciate the instability that comes with a significant swinging motion of the sort generally produced by swing seats, the present inventors have also determined that side-to-side rocking is also disfavored by most dogs. Accordingly, embodiments of the present disclosure are configured to limit side-to-side rocking of the swing seat, e.g. if the person or dog adjusts position during use. This may be achieved by the mounting/support assembly, by the tether assembly, or most desirably both.

In addition to the one or more stability-enhancing features described above, the swing seat may itself be configured for use by a person and a dog. For instance, the swing seat may include a lower element that is sized and configured to support at least a person in a sitting position and at least a medium-sized dog in a lying position, as well as a rear wall that serves as a back support and first and second side walls. At least the lower element may comprise a surface that has slip resistant properties. In some embodiments, at least the lower element may comprise a surface that has slip resistant properties and which is relatively soft, while still being rigid and resilient enough to serve as a seating surface and to hold up to an outdoor environment. In some embodiments, for instance, the lower element may comprise a seating surface that is a slip-resistant rubber material. Such a surface is generally favorable to dogs, as it provides stability and comfort.

In some embodiments, the first and second side walls may comprise the same surface as the lower element, e.g. a slip-resistant rubber material. In some embodiments, for example, the swing seat may comprise an outer framework and surface material, with the perimeter of the surface material being supported by the outer framework. In some embodiments, the first and second side walls of the seat may also extend upward from the lower element at an angle between about 95 and about 140 degrees, which provides a dog with an increased number of different lying positions and provides the swing seat with additional flexibility to accommodate dogs of different sizes. The angling of the first and second side walls in this manner may also operate in conjunction with the suspension/mounting assembly by which the swing seat is suspended from first and second side support posts (rather than from an overhead support bar) to reduce rocking.

The swing seat may also be free of openings in which a dog's paw could get stuck. Because the swing seat is configured for installation and use in an outdoor environment, it is important that the seat be configured for water to drain off the surface of the seat. However, the size of any such drainage opening may be kept relatively small in order to prevent a dog from potentially getting its paw stuck. Moreover, where the seat comprises a surface material that is mounted to an outer framework, any spaces between the surface material and the framework may be sized and configured to prevent be accessed by a dog's paw.

Embodiments of the present disclosure are also directed to a swing seat configured for use by a person and a canine companion, as described herein.

### BRIEF DESCRIPTION OF THE DRAWINGS

A clear conception of the advantages and features of one or more embodiments will become more readily apparent by reference to the exemplary, and therefore non-limiting, embodiments illustrated in the drawings:

FIG. 1 is a top perspective view of an embodiment of a swing assembly in accordance with the present disclosure.

FIG. 2 is a front elevation view of the embodiment illustrated in FIG. 1.

FIG. 3 is a top plan view of the embodiment illustrated in FIG. 1.

FIG. 4 is a bottom perspective view of the embodiment illustrated in FIG. 1.

### DETAILED DESCRIPTION OF THE INVENTION

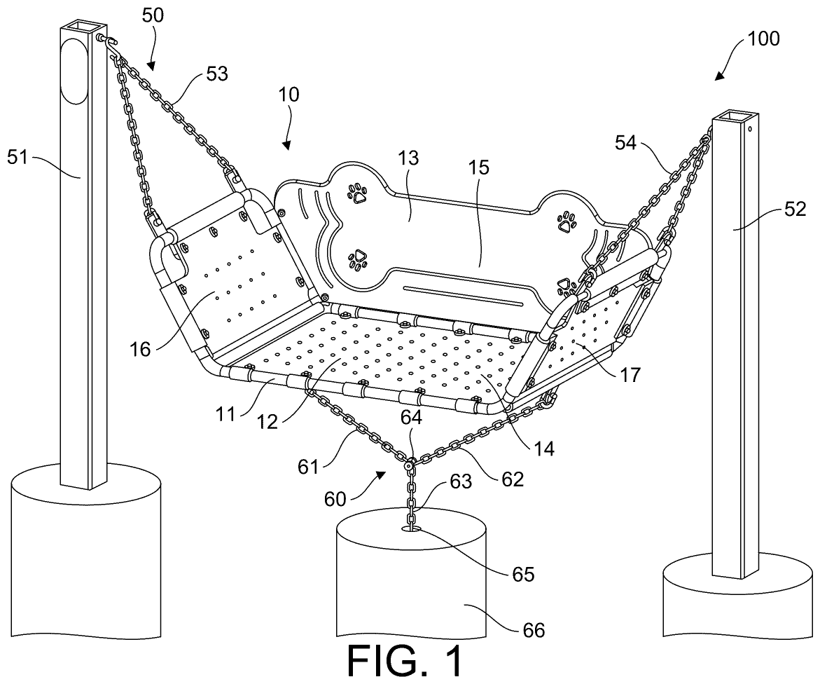

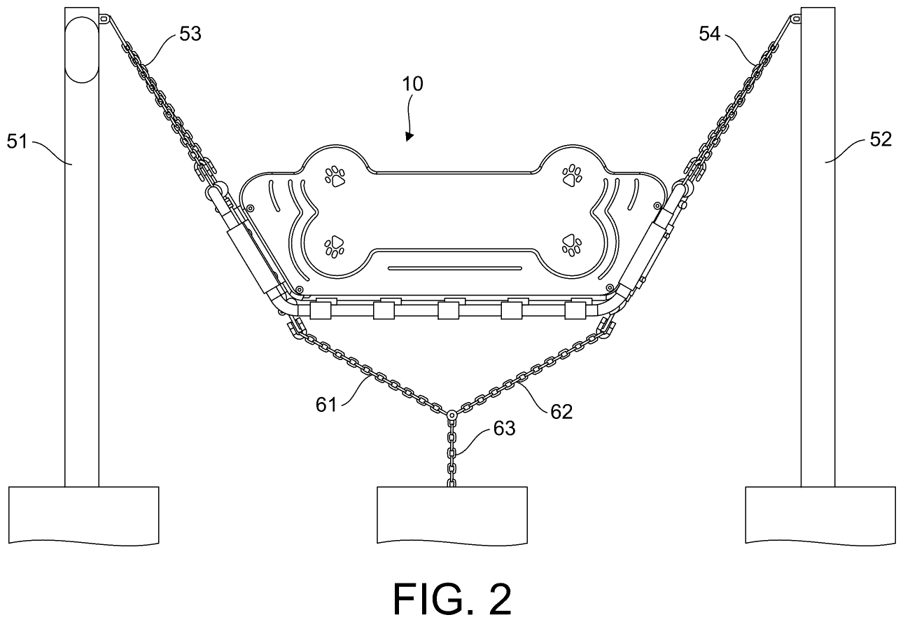

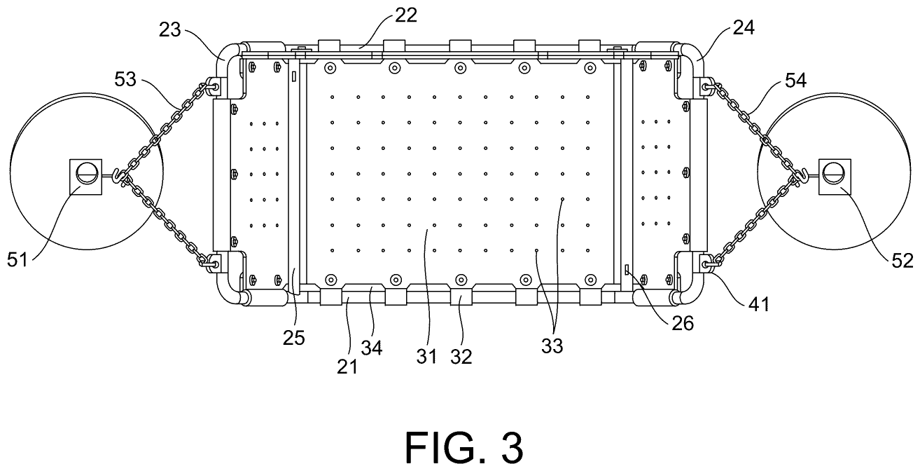

An embodiment of a swing assembly 100 in accordance with the present disclosure is shown in FIGS. 1-3.

The swing assembly 100 comprises a swing seat 10 that is configured to comfortably support both a person (adult or child) and a dog. The seat comprises a framework 11, a seating surface material 12, and a back support 13. Together, these components define a lower seating element 14, a rear wall 15, and first and second side walls 16, 17.

As shown in the illustrated embodiment, the framework 11 comprises a front bar 21 and a rear bar 22. The front bar 21 defines the front edge of the lower seating element 14 and the rear bar 22 defines the rear edge of the lower seating element. In the illustrated embodiment, each of the front and rear bars 21, 22 also curves upward to form front and rear edges, respectively, of the first and second side walls 16, 17. In other non-illustrated embodiments, however, the front and rear edges of the first and second side walls 16, 17 may be defined by separate frame elements, e.g. which may be secured to the front and rear bars 21, 22.

In the illustrated embodiment, the framework 11 further comprises a first side top bar 23 and a second side top bar 24. The first side top bar 23 may define the upper edge of the first side wall 16 and the second side top bar 24 may define the upper edge of the second side wall 17. Each of the first and second side top bars 23, 24 may have a front end that connects with the front bar 21 and a rear end that connects with the rear bar 22. In some embodiments, the first and second side top bars 23, 24 may be integral with the front bar 21 and the rear bar 22, such that the front bar, the rear bar, and the first and second side top bars form a single integral framework element. In other embodiments, the first and second side top bars 23, 24 may be separate elements which may be secured to the front and rear bars 21, 22 or to the separate frame elements that define the front and rear edges of the first and second side walls 16, 17.

In the illustrated embodiment, the framework 11 further comprises a first side bottom bar 25 and a second side bottom bar 26. The first side bottom bar 25 may define the lower edge of the first side wall 16 and the second side bottom bar 26 may define the bottom edge of the second side wall 17. Each of the first and second side bottom bars 25, 26 may have a front end that connects with the front bar 21 and a rear end that connects with the rear bar 22. In some embodiments, the first and second side bottom bars 25, 26 may be integral with the front bar 21 and the rear bar 22, such that the front bar, the rear bar, and the first and second side bottom bars form a single integral framework element. In other embodiments, the first and second side bottom bars 25, 26 may be separate elements which may be secured to the front and rear bars 21, 22 or to the separate frame elements that define the front and rear edges of the first and second side walls 16, 17.

In other, non-illustrated embodiments, the framework 11 may have a different combination of elements, so long as it provides a suitable frame for the surface material 12. In some embodiments, for instance, the framework may not extend up into the first and second sidewalls 16, 17 and may instead only define the boundaries of the lower seating element 14. In such an embodiment, the first and second sidewalls 16, 17 may be independent components, e.g. similar to the back wall 15 of the illustrated embodiment.

The seating surface material 12 extends between the various elements of the framework to provide a surface on which a person may sit and a dog may sit or lay. For instance, the seating surface material 12 may span between the framework elements (e.g. the front bar 21, the rear bar 22, the first side bottom bar 25 and the second side bottom bar 26) that make up the boundaries of the lower seating surface 14. In the illustrated embodiment, the seating surface material 12 may also extend to the upper edges of the first and second side walls 16, 17 (e.g. to the first and second side top bars 23, 24), thereby forming a substantially continuous surface that extends across the lower seating element 14 and both of the side walls 16, 17. As shown in the illustrated embodiment, for example, a portion of the seating surface material 12 may pass underneath each of the first and second side bottom bars 25, 26 and then continue up to the first and second side top bars 23, 24.

The seating surface material 12 may be a sheet of a semi-flexible material, preferably one that provides a desired combination of rigidity, softness, slip resistance, and ability to withstand the outdoor environment in which the swing assembly 100 is installed (e.g. heat, cold, sunlight, moisture, etc.). In some embodiments, the seating surface material 12 may comprise a rubber surface material. In particular, the inventors have found that the rubber materials that are used on conveyor belts may provide a desired combination of factors. In some embodiments, for instance, the seating surface material may comprise a polyester rubber, polyvinyl chloride (PVC) rubber, styrene-butadiene rubber (SBR), polyurethane rubber, or a combination thereof. In other embodiments, the seating surface may comprise a silicone rubber. In some embodiments, the seating surface may comprise or consist of a polyester rubber. In addition to the rubber surface material, the seating surface material 12 may, in some embodiments, include additional internal structural elements, such as one or more layers of a fabric material (e.g. polyester, nylon, or the like), one or more interior cables or mesh (e.g. steel cables or mesh), or a combination thereof.

The seating surface material 12 desirably has anti-slip properties. For example, the seating surface material 12 may have a high coefficient of friction, which provides the surface with good grip, i.e. anti-slip, properties. Such properties are highly desirable, as a surface having good grip properties will help prevent a dog from sliding along the lower seating element 14, which will make the dog uncomfortable during use of the swing assembly 100.

The seating surface material 12 also desirably is softer than the high-density polyethylene that is used on many playground swings. Because many dogs will seek out a soft material on which to lay, using a relatively low durometer surface material 12 will made the swing seat 10 more accommodating to a dog. In some embodiments, for instance, the seating surface material may have a Shore A durometer of 80 or less, alternatively 75 or less, alternatively 70 or less, alternatively 65 or less. In some embodiments, the seating surface material may have a Shore A durometer between about 50 and about 80, alternatively between about 55 and about 75, alternatively between about 60 and about 70, alternatively between about 50 and 70. In some embodiments, the seating surface material may have a Shore A durometer of about 65.

The seating surface material 12 may, as in the illustrated embodiment, be provided with a plurality of perforations 33. These perforations 33 may assist with drainage of environmental moisture (e.g. rain) and may help to keep the surface material 12 cool when the swing assembly is installed in an environment that is subject to high temperatures. In order to prevent a dog from getting his/her paw stuck, these perforations may generally have small cross-section dimensions, e.g. diameters. For instance, each of the perforations 33 may have a maximum cross-section of about 10 mm or less, alternatively about 8 mm or less, alternatively about 7 mm or less, alternatively about 6 mm or less. In some embodiments, the perforations 33 may each be substantially circular and have a diameter of about ¼ inch (about 6 mm). In the illustrated embodiment, the perforations 33 are present on the portions of the seating surface material 12 that form part of the first and second sidewalls 16, 17. However, it is also contemplated that the perforations 33 may only be present on the portion of the seating surface material 12 that is part of the lower seating element 14, as that is where rainwater and the like will otherwise collect.

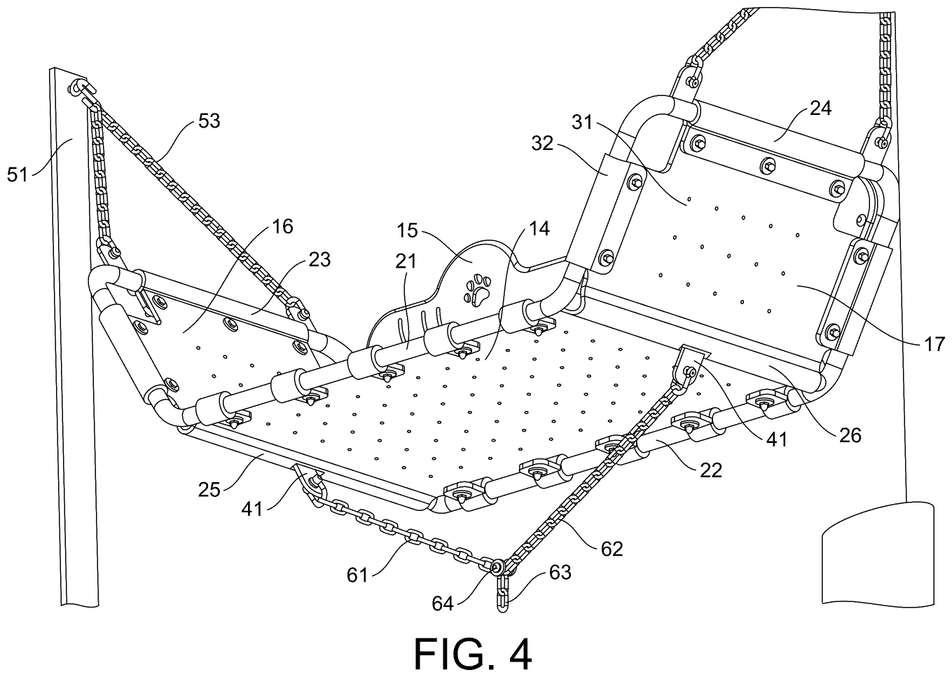

The seating surface material 12 may be attached to the framework 11 in any of a variety of manners. In the illustrated embodiment, the seating surface material 12 is wrapped around each framework element to which it is attached and then secured back on itself. To do so, a sheet of seating surface material 12 includes a main body 31 that is provided, along each side edge, with one or more protruding portions 32. Each of the protruding portions 32 may thus be looped around one of the framework elements (e.g. front bar 21, rear bar 22, first side top bar 23, second side top bar 24, first side bottom bar 25, or second side bottom bar 26) such that an end of the protruding portion is adjacent to a portion of the main body 31 and in parallel alignment with the adjacent portion of the main body. The end of the protruding portion 32 may then be secured to the adjacent portion of the main body by one or more fasteners, for example a bolt that passes through the aligned end of the protruding portion 32 and the adjacent portion of the main body 31 and which is secured in place by a nut. The nut may desirably be positioned on the underside of the seating surface 14 or on the exterior of the side wall 16, 17, in order that the side of the surface material 12 encountered by an occupant of the seat 10 is as smooth as possible. The details of such a securement manner may be seen in FIG. 4.

In the illustrated embodiment, the seating surface material 12 is attached to each of the front bar 21, the rear bar 22, the first top side bar 23 and the second top side bar 24 in the described manner. The seating surface material 12 is not attached to the first and second bottom side bars 25, 26, but rather passes underneath them. In other, non-illustrated embodiments, such as where the seating surface material 12 does not extend up onto the first and second side walls 16, 17, however, the seating surface material may instead be connected to the front bar 21, the rear bar 22, the first bottom side bar 25, and the second bottom side bar 26 in this manner.

Where the seating surface material 12 is attached to the framework 11 in the described manner, the seat 10 may comprise a plurality of apertures 34, or spaces, between the connection points. Those apertures 34 may desirably be sized and configured to prevent a paw of dog from becoming stuck between the surface material 12 and the framework 11. This is of particular relevance on the connection points located on the lower seating element 14, e.g. the connection points between the surface material 12 and the front and rear bars 21, 22 of the framework. For at least each of those apertures, for instance, the distance between the outer edge of the main body 31 of the surface material 12 and the framework element 11 may be kept to about 30 mm or less, alternatively about 28 mm or less, alternatively about 26 or less. In some embodiments, the distance between the outer edge of the main body 31 of the surface material 12 and the framework element 11 may be about 1 inch (about 25 mm).

In some embodiments, including the illustrated embodiment, each of the first and second sidewalls 16, 17 may form an angle with the lower seating element 14 other than 90°. For instance, each of the first and second sidewalls 16, 17 may form an angle of between about 95° and about 145° with the lower seating element 14, alternatively between about 100° and about 140°, alternatively between about 110° and about 130°, alternatively between about 115° and about 125°, alternatively about 120°. Angling of the first and second sidewalls 16, 17 in this manner may provide the seat 10 with enhanced comfort for a dog, as it provides a dog with additional space having a relatively small incline on which to lay. It may also provide the seat 10 with flexibility to accommodate larger dogs while still providing smaller-sized dogs with a feeling of security. And finally, angling of the first and second sidewalls 16, 17 in this manner may facilitate the mounting arrangement shown in the illustrated embodiment and described herein.

The angling of the first and second sidewalls 16, 17 may be provided in a number of different manners. In the illustrated embodiment, the front and rear bars 21, 22 of the framework 11 curve upward into first and second side portions, which form the front edges of the first and second sidewalls. In other embodiments, separate framework elements may be connected together to form the desired angle, or separate side wall elements entirely may be connected to each of the first and second bottom side bars 25, 26 in an angular manner.

The rear wall 15 of the seat may comprise a back support element 13. The back support element 13 may be a rigid and hard plastic component, e.g. made of high density polyethylene (HDPE) or the like. The back support element 13 may have a lower end that is secured to the rear bar 22, e.g. via any of a variety of known fasteners, and an upper end that is generally aligned with the tops of the first and second sidewalls 16, 17. In some embodiments, such as the illustrated embodiment, the back support element 13 may include a visual indicator that the swing seat 10 and swing assembly 100 are suitable for a dog. For instance, as illustrated, the back support element 13 may have the shape of a dog-related item, such as a bone, and/or may include a dog-related item, e.g. paw prints, recessed into or printed on a face of the back support element.

The swing seat 10 may also include a plurality of mounting tabs 41, each of which is configured to receive a mounting element, such as a chain. The mounting tabs 41 may be positioned at various locations around the framework 11 in order to facilitate the mounting assembly by which the swing seat 10 is to be mounted and/or the tethering assembly by which the swing seat is to be tethered to a ground surface. In the illustrated embodiments, for instance, mounting tabs 41 are present on both the first and second top side bars 23, 24 and the first and second bottom side bars 25, 26. More particularly, each of the first and second top side bars 23, 24 include a pair of mounting tabs 41 that are each configured to receive a chain used to suspend the swing seat, whereas each of the first and second bottom side bars 25, 26 include a mounting tab 41 that is configured to receive a chain used to tether the swing seat. As can be seen in FIG. 4, the mounting tab 41 on each of the first and second bottom side bars 25, 26 may extend downward and may pass through an opening that is provided in the seating surface material 12 to accommodate the mounting tab.

In addition to the swing seat 10 configured to comfortably support both a person and a dog, the swing assembly 100 also comprises a support and mounting assembly 50 by which the swing seat 10 is suspended in a manner that provides for a to and fro swinging motion. In some (non-illustrated) embodiments, the swing seat 10 may simply be suspended from an overhead support bar that runs above the swing seat and which between (and typically beyond) the first and second sides of the swing seat, in the same manner as a conventional playground swing.

In other embodiments, including for instance the illustrated embodiment, however, the swing seat 10 may be suspended from a first support post 51 positioned beyond the first side wall 16 of the swing seat and a second support post 52 positioned beyond the second side wall 17 of the swing seat. As shown in FIG. 1, the mounting assembly 50 may thus be free of an overhead support bar. Rather, the supporting structure for the swing seat 10 may consist or consist essentially of the first support post 51 and the second support post 52.

More particularly, the first side wall 16 of the swing seat 10 may be suspendably connected to the first support post 51, e.g. the upper end of the first support post, by a first mounting element 53, and the second side wall 17 of the swing seat may be suspendably connected to the second support post 52, e.g. the upper end of the second support post, by a second mounting element 54. Each of the first and second mounting elements 53, 54 may comprise, for example, one or more chains, cables, ropes, or the like. For instance, the first mounting element 53 may be a chain or a pair of chains having a first end attached to the first side wall 16 of the swing seat 10 and a second end attached to an upper end of the first support post 51, and the second mounting element 54 may be a chain or a pair of chains having a first end attached to the second side wall 17 of the swing seat and a second end attached to an upper end of the second support post 52.

In the illustrated embodiment, for example, the first mounting element 53 comprises a first chain that is attached to a mounting tab 41 positioned at or near the front of the first sidewall 16 and a second chain that is attached to a mounting tab 41 positioned at or near the rear of the first sidewall. Similarly, the second mounting element 54 comprises a first chain that is attached to a mounting tab 41 positioned at or near the front of the second sidewall 17 and a second chain that is attached to a mounting tab 41 positioned at or near the rear of the second sidewall. The first and second support posts 51, 52 may be positioned about midway between the front and rear of the swing seat 10, e.g. about midway between the mounting tabs 41, and the first and second chains of each mounting element 53, 54 may extend frontward and rearward, respectively, from the upper end of the support post to which they are attached.

Rather than extend vertically upward, as is the case with a conventional swing mounting assembly, each mounting element 53, 54 may extend at an angle other than 90° relative to a ground surface to which the swing assembly 100 is mounted. For instance, each mounting element 53, 54 may form an angle between about 95° and about 145° with the ground surface to which the swing assembly is mounted, alternatively between about 100° and about 140°, alternatively between about 110° and about 130°, alternatively between about 115° and about 125°, alternatively about 120°. As shown in the illustrated embodiment, the angle of each of the first and second mounting elements 53, 54 relative to the ground surface may be substantially the same as the angle formed by each of the first and second sidewalls 16, 17 with the lower seating element 14. This may provide additional stability to the swing seat 10 during operation.

By utilizing a mounting assembly 50 such as that described herein, the side-to-side movement and/or rocking of the swing seat 10 may be restrained to a greater degree than would be the case with a conventional overhead mount. It has been found that by reducing the degree of side-to-side movement and/or rocking of the swing seat 10, the swing assembly 100 may be more acceptable to dogs, who prefer enhanced stability over the more intense movements associated with conventional playground swings.

Embodiments of the swing assembly 100 may also include a tether 60, by which the swing seat 10 is operably connected to a ground surface, e.g. the ground surface to which the support assembly is mounted. The tether 60 serves to limit the forward and rearward movement of the swing during the to and fro swinging motion, in order to provide a swinging motion that is more acceptable to a dog than the more intense movement associated with a conventional playground swing.

In some embodiments, for instance, the tether 60 may limit the swing to an overall swing angle of 55 degrees or less, alternatively an overall swing angle of 50 degrees or less, alternatively an overall swing angle of 45 degrees or less, alternatively an overall swing angle of 40 degrees or less. In some embodiments, for instance, the tether 60 may limit the swing to a maximum angle of about 20 degrees in each of the forward and rearward directions (for an overall maximum swing angle of about 40 degrees). In order that the assembly 100 still operate as a swing, however, the tether 60 should allow for an overall swing angle of at least 10 degrees, alternatively at least 15 degrees, alternatively at least 20 degrees. In some embodiments, for example, the tether 60 may be configured such that the overall maximum swing angle of the swing seat 10 is between about 20 degrees and about 50 degrees, alternatively between about 20 degrees and about 40 degrees.

Put another way, in some embodiments the tether 60 may be configured to limit the swing seat 10 to a maximum of between about 6 inches and about 12 inches of forward movement from the rest position and a maximum of between about 6 inches and about 12 inches of backward movement from the rest position; alternatively the tether may be configured to limit the swing seat to a maximum of between about 6 inches and about 10 inches of forward movement from the rest position and a maximum of between about 6 inches and about 10 inches of backward movement from the rest position; alternatively the tether may be configured to limit the swing seat to a maximum of about 8 inches of forward movement from the rest position and a maximum of about 8 inches of backward movement from the rest position.

The tether 60 may take on any of a variety of configurations. In some (non-illustrated) embodiments, for example, the tether 60 may comprise one or more elements, e.g. chain, cable, rope, or the like, each of which having a first end attached to the swing seat 10 and a second end mounted to the ground. For example, the tether 60 may comprise a single element, e.g. chain, cable, rope, or the like, having a first end attached to the swing seat 10, desirably at or near a center of the swing seat, and a second end mounted to the ground. Or the tether 60 may comprise two elements, e.g. chains, cables, ropes, or the like, each of which has a first end attached to the swing seat 10 and a second end mounted to the ground; for example a first tether element attached to the swing seat at a first side of the seat and a second tether element attached to the swing seat at a second side of the seat, with the first and second tether elements angling inward to a ground mounting location positioned under the center of the swing seat.

In other embodiments, including the illustrated embodiment, the tether 60 may include a first tether element 61 attached to the swing seat 10 at a first side of the seat and a second tether element 62 attached to the swing seat at a second side of the seat. Each of the first and second tether elements 61, 62 extend inward from the side of the seat such that the first and second tether elements are joined together at a location under the seat and desirably at or near the center of the seat. Rather than being directly connected to the ground (as described in the previous paragraph) however, the first and second tether elements 61, 62 are joined to a third tether element 63, which extends downward from that connection point, or hub 64, to the ground surface. Where the hub 64 is positioned at or near the center of the seat, the third tether element 63 may extend substantially vertically between the hub and the ground surface.

This multi-component tethering assembly 60 provides the swing seat 10 with greater side-to-side stability, e.g. anti-rocking effects, than a single vertical tether for instance. It also provides better control over the allowable swinging motion than multiple direct-to-ground tethers. By keeping all of the tether elements positioned underneath the footprint of the swing seat 10, the tether 60 may also generally be prevented from becoming a tripping hazard.

The first end of the first tether element 61 and the first end of the second tether element 62 may each be attached to the swing seat 10 in any of a variety of manners. In the illustrated embodiment, the swing seat 10 comprises mounting tabs 41 that extend downward along the first and second bottom edges of the seat and to which the first ends of the first and second tether elements are attached. More specifically, as can be seen in FIG. 4, each of the first and second bottom side bars 25, 26 may include a mounting tab 41 that extend downwards and which optionally may pass through an opening that is provided in the seating surface material 12. The first tether element 61 may be attached to the mounting tab 41 extending from the first bottom side bar 25 and the second tether element 62 may be attached to the mounting tab 41 extending from the second bottom side bar 26. The second end of each of the first and second tether elements 61, 62 may connect to the hub 64 (or in a non-illustrated embodiment to the ground surface).

As shown in the illustrated embodiment, a first end of the third tether element 63 is connected to the hub 64 and a second end of the third tether element is mounted to the ground surface. In other (non-illustrated) embodiments, the second end of one or more tether elements may be mounted directly to the ground surface. Mounting of the third tether element 63 (or a different tether element) to the ground surface may be achieved in a number of manners. As illustrated, for instance, a mounting element, such as a mounting ring 65, may extend from the ground surface or be positioned within the ground and a second end of the tether element 63 may be secured to the mounting element. The mounting element 65 may also include a below-ground portion such as a post and/or a foundation 66, e.g. of cement, concrete, etc., to ensure that the mounting element remains secured in the ground.

It can be seen that the described embodiments provide a unique and novel swing seat assembly 100 that have a number of advantages over those in the art. While there is shown and described herein certain specific structures embodying the invention, it will be manifest to those skilled in the art that various modifications and rearrangements of the parts may be made without departing from the spirit and scope of the underlying inventive concept and that the same is not limited to the particular forms herein shown and described except insofar as indicated by the scope of the appended claims.

What is claimed:

1. A swing configured for use by a person and his or her dog, comprising:
a seat having
a lower element configured to support at least a person in a sitting position and a dog,
a rear wall, and
first and second side walls;
a tether connecting the seat to a ground surface, the tether being configured to limit the forward and rearward movement of the swing.

2. The swing of claim 1, wherein the tether comprises a first tether element attached to the seat at a first side of the seat and a second tether element attached to the seat at a second side of the seat, each of the first and second tether elements extending inward from the side of the seat such that the first and second tether elements are joined at the center of the seat.

3. The swing of claim 2, further comprising a third tether element extending substantially vertically between a connection point of the first and second tether elements and a ground surface.

4. The swing of claim 2, wherein
the first tether element is attached to a support bar that extends between a front and a rear of the seat and which forms a border between the lower element and the first side wall of the seat, and
the second tether element is attached to a support bar that extends between a front and a rear of the seat and which forms a border between the lower element and the second side wall of the seat.

5. The swing of claim 1, wherein the tether comprises one or more chains.

6. The swing of claim 1, further comprising a first mounting element and a second mounting element;
the first mounting element having a first end attached to the first side wall of the seat and a second end attached to a first support post, the first support post being positioned on a first side of the seat; and
the second mounting element has a first end attached to the second side wall of the seat and a second end attached to a second support post, the second support post being positioned on a second side of the seat.

7. The swing of claim 6, further comprising a support assembly, wherein the support assembly consists essentially of the first support post and the second support post.

8. The swing of claim 6, wherein each of the first and second mounting elements comprises a first chain attached to a front end of the side wall and a second chain attached to a rear end of the side wall.

9. The swing of claim 8, wherein the first and second side walls of the seat extend upward from the lower element at an angle between about 100 degrees and about 140 degrees; and wherein the chains extend between the support post and the seat at substantially the same angle.

10. The swing of claim 1, wherein the seat comprises an outer framework and a surface material.

11. The swing of claim 10, wherein the surface material is a rubber material having a Shore A durometer of 80 or less.

12. The swing of claim 11, wherein the rubber material is slip resistant.

13. The swing of claim 10, wherein the surface material comprises a main body and one or more protruding portions on each side of the main body, each of the protruding portions being looped around a portion of the outer framework and affixed to the main body of the surface material in order to secure the surface material to the framework.

14. The swing of claim 13, further comprising
a first support bar that spans between a front and a rear of the framework and which forms a boundary between the lower element and the first side wall, and
a second support bar that spans between a front and a rear of the framework and which forms a boundary between the lower element and the first side wall;
wherein the surface material is passed underneath each of the first and second support bars.

15. The swing of claim 13, wherein, at least on the lower element, spaces between the main body of the surface element and the framework are configured to be too small for a paw of dog to become stuck between the surface element and the framework.

16. The swing of claim 10, wherein the surface element has perforations at least along a portion that forms part of the lower element.

17. The swing of claim 10, wherein the framework has a horizontal portion that frames the lower element, a first side portion that frames the first side wall, and a second side portion that frames the second side wall; and
wherein the horizontal portion curves upward into the first and second side portions, such that the first and second side walls form an angle between about 100 degrees and about 140 degrees with the lower element.

18. The swing of claim 10, wherein the seat further comprises a back support element that is affixed to the outer framework to form the rear wall of the seat.

19. The swing of claim 18, wherein the back support element comprises a visual indicator that the swing is suitable for a dog.

20. The swing of claim 1, wherein the tether is configured to limit the forward and rearward movement of the swing to an overall swing angle of 50 degrees or less.
